(19) United States
(12) Patent Application Publication
(10) Pub. No.: US 2021/0073816 A1
(43) Pub. Date: Mar. 11, 2021

(54) SYSTEMS AND METHODS FOR GUARANTEE OF FUNDS FOR ACH TRANSACTIONS

(71) Applicant: Mastercard International Incorporated, Purchase, NY (US)

(72) Inventors: Stephanie M. Detchemendy, Wentzville, MO (US); James Fisher, Villa Ridge, MO (US); Sachin Devajirao Ingle, O'Fallon, MO (US)

(73) Assignee: Mastercard International Incorporated, Purchase, NY (US)

(21) Appl. No.: 16/566,075

(22) Filed: Sep. 10, 2019

(51) Int. Cl. G06Q 20/40; G06Q 20/02; G06Q 20/26

(52) U.S. Cl. CPC G06Q 20/4012; G06Q 20/26; G06Q 20/023

(57) ABSTRACT

Methods and systems for real-time verification of funds availability for ACH debit transactions include receiving, for a transaction, a request to debit a first amount of funds from a consumer deposit account. The request includes transaction data including an account identifier associated with the consumer deposit account. Using the account identifier, an entry of a routing table is identified, where the entry identifies one or more payment processing networks that are eligible to process the transaction, and a separate verification network that is eligible to verify a second amount of funds available from the consumer deposit account. A pre-authorization request message is transmitted to the identified verification network. Subsequently, a pre-authorization response message is received from the verification network verifying that the second amount of funds available from the consumer deposit account is greater than or equal to the requested first amount of funds. The transaction is processed using the identified payment processing network.

### FIELD OF THE DISCLOSURE

The field of the disclosure relates generally to payment transactions made over the automated clearing house (ACH) network and, more specifically, to systems and methods for verifying funds availability for ACH debit transactions.

### BACKGROUND

Among existing methods of performing payment transactions, particularly consumer payment transactions, and transferring funds from one person to another, ACH transactions are utilized less than typical debit and/or credit card transactions. ACH transactions, however, are widely utilized for bill payment transactions such as utility bills, rent, mortgages, and loans, and for receiving salary payments from an employer. In such cases where ACH debit transactions are utilized; a consumer typically provides an account number and routing number for direct transfer of funds from the consumer's deposit account to a merchant's account. ACH debit transactions, however, have no pre-authorization process to verify and/or guarantee the availability of funds from the consumer account. Accordingly, retail-type merchants (e.g., item/goods based merchants and point of sale (POS) transactions), typically utilize non-ACH payment methods, such as the debit and/or credit card transactions described above.

ACH transactions are generally known for having fewer fees than typical debit and/or credit card transactions because funds are transferred directly between accounts. However, because there is no process to verify and/or guarantee the availability of funds prior to initiating the transaction, the merchant assumes the risk of having the transaction returned during clearing or settlement due to, for example, the consumer's account being closed, insufficient funds, and the like. Because there is a delay in clearing typical ACH debit transactions, the merchant may not be able to recover the goods or services sold and/or recover the funds from the consumer without substantial expense.

The delay encountered with ACH debit transactions is inherent in the way the transactions are handled. For example, an ACH transaction, or entry, is initiated by an originator (e.g., a company or organization) that is directing the transfer of funds on behalf of, and with the authorization of, a receiver (e.g., a customer). Thus, the originator and receiver refer to the entities that initiate and receive an ACH entry, which may be either a credit or a debit to the receiver's account. An originator sends the transfer instructions to an originating depository financial institution (ODFI), which forwards the ACH entries to an ACH operator (e.g., a Federal Reserve Bank) for settlement. The ACH entries are then sent to the respective receiving depository financial institutions (RDFI) where they are posted to the appropriate depositor's (receiver's) accounts. Although ACH transactions are generally conducted electronically, they are typically batch-processed instead of being handled one at a time.

After an ACH entry is accepted, the entries are settled on the assumption that the funds are available and will be transferred as specified. Settlement of an ACH entry generally occurs on the business day following its initiation. However, as discussed above, even after settlement, an RDFI may “return” an ACH debit entry due to insufficient funds in the receiver's account. Thus, settlement of an ACH debit does not guarantee that the receiver has sufficient funds to cover the entry. If the originator, or the ODFI processing an ACH entry for the originator, releases the funds of the entry too soon, and the RDFI later determines that the receiver has insufficient funds and therefore “returns” the entry, the originator or ODFI may be at risk of losing those funds.

Thus, if ACH debit transactions could be pre-authorized and/or funds availability verified prior to processing the ACH debit transactions, merchants' costs would be decreased, and the savings could be passed on to the consumers. Accordingly, a system is needed in which ACH debit transactions amounts can be indicated as sufficiently covered by a consumer account so that they may be ‘held’ in reserve to ensure the funds are not spent prior to processing over the ACH network.

### BRIEF DESCRIPTION

This brief description is not intended to identify essential features of the present disclosure and is not intended to be used to limit the scope of the claims. These and other aspects of the present disclosure are described below in greater detail.

In one aspect, a method is provided. The method includes receiving, for a transaction, a request to debit a first amount of funds from a consumer deposit account. The request includes transaction data including an account identifier associated with the consumer deposit account. In addition, the method includes identifying, using the account identifier, an entry of a routing table. The entry identifies one or more payment processing networks that are eligible to process the transaction, and a separate verification network that is eligible to verify a second amount of funds available from the consumer deposit account. Furthermore, the method includes transmitting a pre-authorization request message to the identified verification network. Moreover, the method includes receiving a pre-authorization response message from the verification network verifying that the second amount of funds available from the consumer deposit account is greater than or equal to the requested first amount of funds. Additionally, the method includes processing the transaction using the identified payment processing network.

In another aspect, a system is provided. The system includes a network interface, a memory device including a routing table, and a processor communicatively coupled to the memory device. The processor is programmed to receive a transaction from a merchant via the network interface. The transaction includes a request to debit a first amount of funds from a consumer deposit account. The request includes transaction data including an account identifier associated with the consumer deposit account. In addition, the processor is programmed to identify, using the account identifier, an entry of the routing table. The entry identifies one or more payment processing networks that are eligible to process the transaction. The entry also identifies a separate verification network that is eligible to verify a second amount of funds available from the consumer deposit account. The processor is further programmed to transmit a pre-authorization request message to the identified verification network via the network interface. Moreover, the processor is programmed to receive, via the network interface, a pre-authorization response message from the verification network verifying that the second amount of funds available from the consumer deposit account is greater than or equal to the requested first amount of funds. Furthermore, the processor is programmed to process the transaction using the identified payment processing network.

In yet another aspect, one or more non-transitory computer-readable storage media is provided. The computer-readable storage media has computer-executable instructions embodied thereon, which when executed by at least one processor, the computer-executable instructions cause the processor to receive, for a transaction, a request to debit a first amount of funds from a consumer deposit account. The request includes transaction data including an account identifier associated with the consumer deposit account. The computer-executable instructions further cause the processor to identify, using the account identifier, an entry of a routing table. The entry identifies one or more payment processing networks that are eligible to process the transaction. The entry also identifies a separate verification network that is eligible to verify a second amount of funds available from the consumer deposit account. Furthermore, the computer-executable instructions cause the processor to transmit a pre-authorization request message to the identified verification network. In addition, the computer-executable instructions cause the processor to receive a pre-authorization response message from the verification network verifying that the second amount of funds available from the consumer deposit account is greater than or equal to the requested first amount of funds. Moreover, the computer-executable instructions cause the processor to process the transaction using the identified payment processing network.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example multi-party payment card network system;

FIG. 2 is a block diagram illustrating an example automated clearing house (ACH) payment processing system, in which funds are transferred directly and electronically from a consumer deposit account to a merchant account over an ACH network;

FIG. 3 is a block diagram of an ACH debit transaction pre-authorization system, in accordance with one embodiment of the present disclosure;

FIG. 4 is a schematic front view of the transaction card for use with the systems shown in FIGS. 1-3;

FIG. 5 is a schematic of a routing table (or bank identification number (BIN) routing table), in accordance with one embodiment of the present disclosure;

FIG. 6 is an example configuration of a computer system operated by a user, such as a merchant shown in FIG. 3;

FIG. 7 is an example configuration of a server system, such as a server system shown in FIG. 1;

FIG. 8 is a flowchart illustrating an exemplary computer-implemented method for real-time verification of funds availability for an ACH debit transaction where funds are transferred directly and electronically from a consumer deposit account to a merchant account, in accordance with one embodiment of the present disclosure; and

FIG. 9 is a flowchart illustrating the transaction processing details of a transaction processing operation shown in FIG. 8.

The figures depict exemplary embodiments for purposes of illustration only. The figures are not intended to limit the present disclosure to the specific embodiments they depict. One skilled in the art will readily recognize from the following discussion that alternative embodiments of the systems and methods illustrated herein may be employed without departing from the principles of the disclosure described herein.

### DETAILED DESCRIPTION

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. The scope of the present disclosure is defined only by the appended claims, along with the full scope of equivalents to which such claims are entitled. It is contemplated that the disclosure has general application to providing fund verification in ACH debit transactions in industrial, commercial, and residential applications.

Embodiments of the present technology relate to systems, computer-readable media, and computer-implemented methods for real-time verification of funds availability for ACH debit transactions where funds are transferred directly and electronically from a consumer deposit account to a merchant account. Embodiments of the present technology reduce the risk to a merchant of an ACH debit transaction being returned due to insufficient funds, account closure, etc.

As used herein, the term “real-time” includes the time of occurrence of the associated events, the time to process data, and/or the time of a system response to the events and the environment. In the embodiments described herein, these activities and events occur substantially instantaneously.

According to one embodiment of the disclosure, a computing system is configured to receive a request to debit an amount of funds from a consumer deposit account (referred to herein as a “first amount”). The request includes an account identifier associated with the consumer deposit account. The account identifier is scanned or read from a consumer's transaction card. In addition, the request includes an account number for the consumer deposit account and a routing transit number (RTN) for the issuer of the transaction card.

The computing system extracts a bank identification number (BIN) from the account identifier and uses it to determine an ACH payment processing network that is eligible to process the transaction, and a separate verification network that is eligible to verify an amount of funds available from the consumer deposit account (referred to herein as a “second amount”). By using the separate verification network to verify an amount of funds available from the consumer deposit account, the system may process the ACH debit transaction on the ACH network while reducing risk to the merchant of having the ACH debit transaction returned.

The methods and systems described herein may be implemented using computer programming or engineering techniques including computer software, firmware, hardware, or any combination or subset therefor. At least one of the technical problems addressed by this system includes no pre-authorization process to verify and/or guarantee the availability of funds from a consumer account for an ACH debit transaction.

A technical effect of the systems and methods described herein is achieved by performing at least one of the following operations: (i) receiving a request to debit a first amount of funds from a consumer deposit account; (ii) identifying, using the account identifier, an entry of a routing table; (iii) using the entry to identify a payment processing network that is eligible to process the transaction; (iv) using the entry to identify a separate verification network that is eligible to verify a second amount of funds available from the consumer deposit account; (v) transmitting a pre-authorization request message to the identified verification network; and (vi) processing the transaction using the identified payment processing network.

The resulting technical effect achieved by the systems and methods described herein is at least one of: (i) verifying the availability of funds from the consumer account; (ii) reducing the risk to a merchant when processing ACH debit transactions; (iii) reducing the costs to a merchant for processing transactions; and (iv) reducing occurrences of rejected and returned ACH debit transactions and the associated costs.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

As will be appreciated, based on the description herein, the technical improvement in verifying and/or guaranteeing the availability of funds from a consumer account for an ACH debit transaction as described is a computer-based solution to a technical deficiency or problem that is itself rooted in computer technology (i.e., the problem itself derives from the use of computer technology). More specifically, the technical problems and inefficiencies created by conventional ACH transaction processing and related methods are the result of an implementation and use of computers in those ACH transaction systems and methods. The present disclosure improves upon the conventional methods and systems in the manners described herein. Thus, the inefficiencies or technical problems created by the conventional ACH transaction systems and methods as described herein are solved by the methods and systems described and particularly claimed herein.

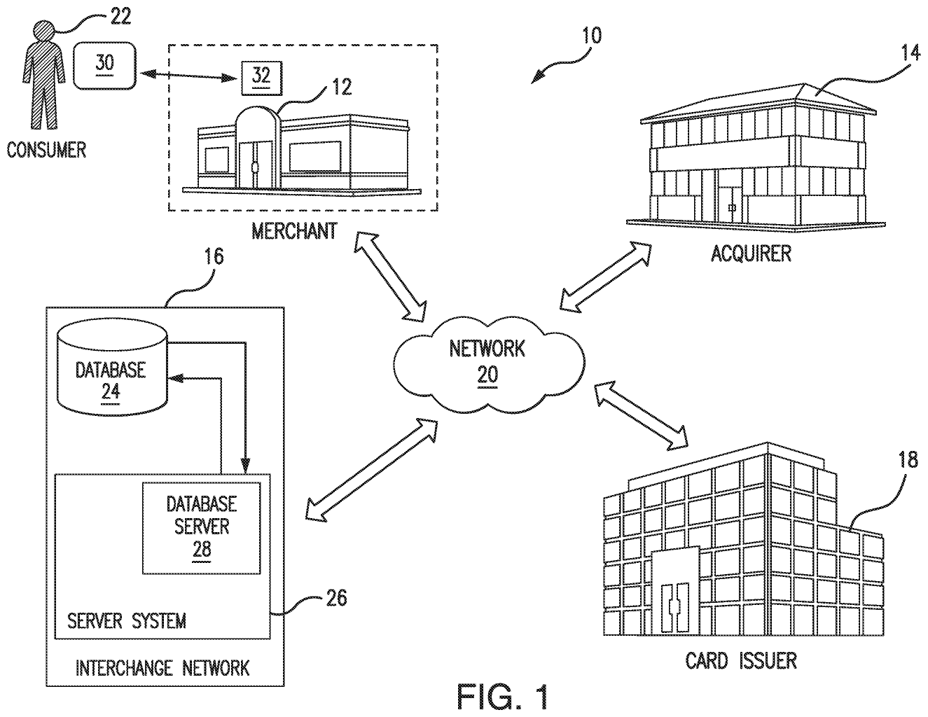

FIG. 1 is a block diagram illustrating an example multi-party payment card network system 10. The example payment card network system 10 generally includes merchants 12, acquirers 14, an interchange network 16, and card issuers 18, coupled in communication via a network 20. As used herein, the term “interchange network” includes an electronic network that exchanges data relating to the value of card sales and credits among the issuers 18 and the acquirers 14 (e.g., networks maintained, for example, by Discover®, Mastercard®, American Express®, or VISA®).

The payment card network system 10 facilitates providing interchange network services offered by the interchange network 16. In addition, the payment card network system 10 enables payment card transactions in which the merchants 12, acquirers 14, and/or card issuers 18 do not need to have a one-to-one relationship. As an example, the payment card network system 10 may be utilized by the merchants 12 as part of a process of initiating a pre-authorization request for performing a transaction (as described herein). Although parts of the payment card network system 10 are presented in one arrangement, other embodiments may include the same or different parts arranged otherwise, depending, for example, on pre-authorization processes for purchase transactions, communication between computing devices, etc.

The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. Additionally, the network 20 may include more than one type of network, such as a private payment transaction network provided by the interchange network 16 to the acquirers 14 and/or the issuers 18, and separately, the public Internet, which may facilitate communication between the merchants 12, the interchange network 16, the acquirers 14, and/or consumers.

Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data includes a unique account number associated with an account holder using a payment card issued by an issuer, purchase data representing a purchase made by the consumer, including a type of merchant, amount of purchase, date of purchase, and other data, which may be transmitted between any parties of multi-party payment card network system 10.

In a transaction card system as described herein, a financial institution called the “issuer” issues a transaction card 30, such as a debit card, to a consumer or consumer 22, who uses the transaction card 30 to tender payment for a purchase from the merchant 12. The merchant 12 is typically associated with products, for example, and without limitation, goods and/or services, that are offered for sale and are sold to the consumers 22. The merchant 12 includes, for example, a physical location and/or a virtual location. A physical location includes, for example, a brick-and-mortar store, etc., and a virtual location includes, for example, an Internet-based store-front.

To accept payment with the transaction card 30, the merchant 12 must normally establish an account with a financial institution that is part of the payment card network system 10. This financial institution is usually called the “merchant bank,” the “acquiring bank,” or the acquirer 14. When the consumer 22 provides payment for a purchase with the transaction card 30, the merchant 12 requests pre-authorization from the acquirer 14 for the purchase amount. The request may be performed over the telephone but is usually performed using a point-of-sale (POS) terminal, such as POS terminal 32, that reads the consumer's account information (such as a primary account number (PAN)) from a magnetic stripe, a chip, or embossed characters on the transaction card 30 and communicates electronically with the transaction processing computers of the acquirer 14. Alternatively, the acquirer 14 may authorize a third party to perform transaction processing on its behalf. In this case, the POS terminal 32 will be configured to communicate with the third party. Such a third party is usually called a “merchant processor,” an “acquiring processor,” or a “third party processor.”

Using the interchange network 16, computers of the acquirer 14 or merchant processor communicate with computers of the issuer 18 to determine whether the consumer's account, for example, a demand deposit account (DDA), linked to the PAN is in good standing and whether the purchase transaction is covered by the consumer's available funds (e.g., for electronic funds transfers (EFTs) and/or automated clearing house (ACH) transactions). Based on these determinations, the request for pre-authorization will be declined or accepted. If the request is accepted, a pre-authorization code is issued to the acquirer 14 and the merchant 12 for the amount of the transaction or the requested estimated amount.

When a request for pre-authorization is accepted, the interchange network 16 and/or the issuer 18 may store transaction data, such as, and without limitation, the PAN, a type of merchant, a merchant identifier, a location where the transaction was performed, a dollar amount of the transaction, a merchant category code, a date and time of the transaction, products purchased and related descriptions or identifiers, etc., in a transaction database 24.

After the transaction has been pre-authorized, a clearing process occurs to transfer additional transaction data related to the transaction among the parties to the transaction, such as the acquirer 14 and the issuer 18. More specifically, during and/or after the clearing process, additional data, such as a time of purchase, a merchant name, a type of merchant, purchase information, consumer account information, a type of transaction, itinerary information, information regarding the purchased item and/or service, and/or other suitable information, is associated with the transaction and transmitted between parties to the transaction as transaction data, and may be stored by any of the parties to the transaction.

While only one merchant 12, acquirer 14, interchange network 16, and issuer 18 are shown in FIG. 1 (for ease of reference), it should be appreciated that a variety of other embodiments may include multiple ones of these parts in various combinations.

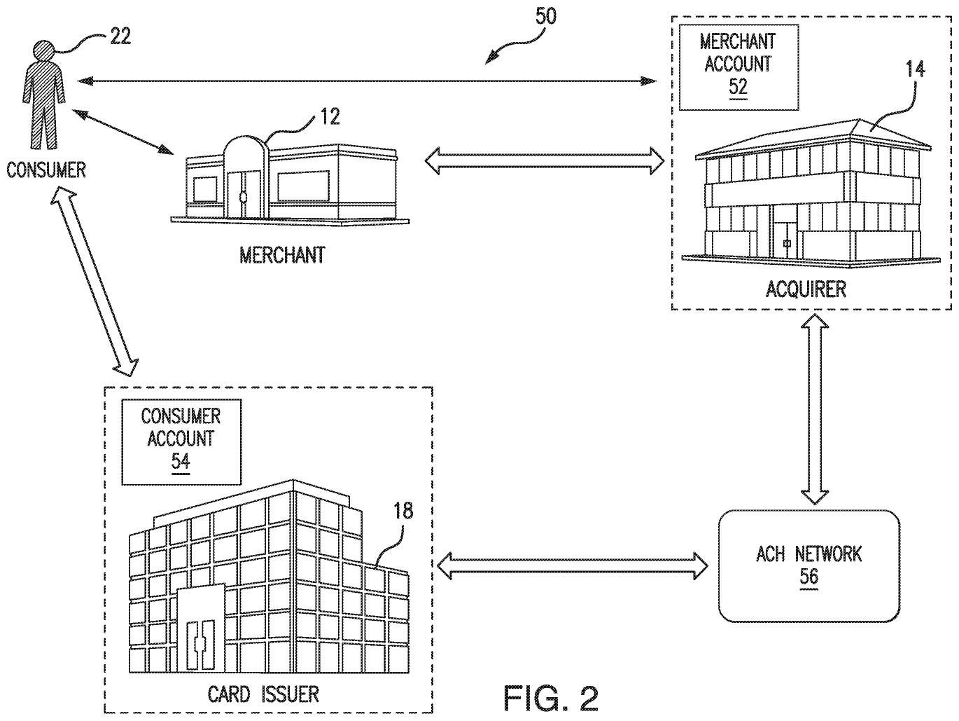

FIG. 2 is a block diagram illustrating an example automated clearing house (ACH) payment processing system 50, in which funds are transferred directly and electronically from a consumer deposit account 54 to a merchant account 52 over an ACH network 56. For a conventional ACH payment transaction, the consumer 22 provides an account number of the consumer deposit account 54, and in some instances, a routing transit number (RTN) of the issuer 18, to the merchant 12, or in some instances, the acquirer 14. If the merchant 12 receives the account information, it is then transmitted to the acquirer 14. The acquirer 14 typically accumulates transactions over a discrete period (e.g., one business day) and transmits the accumulated transactions as a batch to the issuer 18 over the ACH network 56. Issuer 18 is the bank or financial institution that issued the consumer deposit account 54 and its associated transaction card 30 to the consumer 22. As described herein, the acquirer 14 is associated with the merchant 12. After transmission of the transactions, if the account information for the transaction is valid and there are sufficient funds available to cover a consumer's transaction, funds will be transferred electronically and directly from the consumer deposit account 54 to the merchant account 52. If the account information is invalid and/or there are not enough funds available to cover the transaction, the transaction is rejected or returned, and no funds are transferred. No further authentication of the consumer 22 or the consumer's association with the provided account number, or further authorization by the issuer 18 to release funds from the consumer deposit account 54, is required or included in the ACH debit transaction.

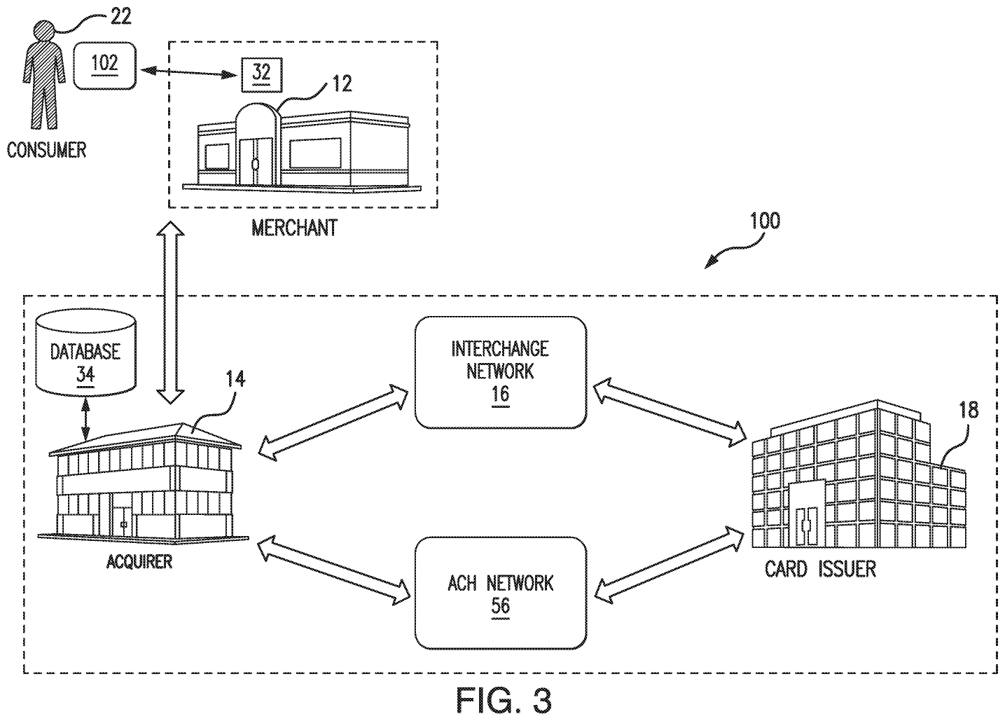

FIG. 3 is a block diagram of an ACH transaction pre-authorization system 100, in accordance with one embodiment of the present disclosure. The ACH transaction pre-authorization system 100 facilitates real-time funds availability verification for an ACH debit transaction where funds are transferred directly and electronically from the consumer deposit account 54 (shown in FIG. 2) to the merchant account 52 (shown in FIG. 2). The ACH transaction pre-authorization system 100 may be utilized by the acquirer 14 as part of a process of initiating a pre-authorization request via the interchange network 16 and performing an ACH debit transaction via the ACH network 56. In the example embodiment, the ACH transaction pre-authorization system 100 generally includes the acquirer 14 coupled in communication to the issuer 18 via the interchange network 16 and the ACH network 56.

In the example embodiment, the consumer 22 performs a transaction at the merchant 12 using a transaction card 102. The transaction card 102 is scanned, or read, by the POS terminal 32. In the example embodiment, unlike a traditional payment card, the transaction card 102 includes a PAN linked to the consumer deposit account 54 and the account number of the consumer deposit account 54 and the associated routing transit number (RTN) of the issuer 18. The POS terminal 32 reads and temporarily stores the PAN, the account number of the consumer deposit account 54, and the RTN. In an alternative embodiment, mapping of the PAN to the account number of the consumer deposit account 54 and the associated RTN of the issuer 18 may be maintained separately from the transaction card 102. For example, and without limitation, the interchange network 16 may maintain a database including such mapping detail.

Generally, the PAN comprises a sixteen account digit number and is allocated in accordance with ISO/IEC 7812. The sixteen digit account number may include a four or six digit Bank Identification Number (BIN) and/or Issuer Identification Number (IIN). The first digit of the BIN may include a Major Industry Identifier (MII), which represents the category of the entity that issued the payment account. For example, a value of the MII digit equal to 3, 4, 5, or 6 implies a banking or financial institution. BIN values are often used to assist in determining how to route financial transaction data to an issuer of a payment account. Generally, merchants and acquirers utilize BIN tables (not shown in FIG. 3) to determine which payment processing network is to be used to route a transaction. These BIN tables, also commonly referred to as routing tables, BIN routing tables, or BIN databases, often include entries that each map a BIN of an account to a particular processing network (or, to a specific endpoint within the processing network within which it resides) to be used for routing transactions having that BIN of an issuer. Thus, upon receipt of transaction information (e.g., a pre-authorization request message) from a merchant including a PAN of an account of the consumer 22 in the transaction, the acquirer 14 may identify the BIN portion of the PAN and use it as an index (or key) into the BIN table to identify a processing network to be used to route the transaction information toward the correct issuer. In the exemplary embodiment, the transaction card 102 includes a BIN value that indicates that the transaction is a verifiable ACH debit transaction, i.e., the transaction may be verified via the interchange network 16 and cleared and settled on the ACH network 56.

After receiving the PAN, the account number of the consumer deposit account 54, and the RTN, the acquirer 14 identifies the processing network, such as the interchange network 16, via the BIN and the BIN routing tables, and transmits a pre-authorization request to the interchange network 16 using the encoded PAN from the transaction card 102. The interchange network 16 forwards the pre-authorization request to the issuer 18. The issuer 18 determines whether the consumer deposit account 54 linked to the PAN is in good standing and whether the purchase transaction is covered by the consumer's available funds. Based on the determination, the request for pre-authorization will be declined or accepted. If the request is accepted, a pre-authorization code is transmitted back to the acquirer 14 and/or the merchant 12 for the amount of the transaction.

In the exemplary embodiment, the pre-authorization request is implemented substantially the same as a dual message transaction in a typical interchange network transaction. In a typical dual message transaction, pre-authorization or authorization is performed as a first step of the transaction process and settlement is performed as a second step. However, in the exemplary embodiment, the second step of the transaction process is not completed by the interchange network 16. Rather, based on the BIN and the BIN routing tables, the pre-authorized transaction is performed as an ACH transaction, wherein the transaction is cleared and settled on the ACH network 56. As such, this enables the merchant 12 and/or the acquirer 14 to verify in real-time the availability of funds for an ACH debit transaction, thereby reducing risk of the consumer's account having insufficient funds and/or being closed when settlement occurs, while simultaneously reducing operational costs incurred by merchants and acquirers resulting from clearing and settlement of payment card transactions on the interchange network 16. In one embodiment, when the request for pre-authorization is accepted, the acquirer 14 may store transaction data, such as, and without limitation, the PAN, the account number of the consumer deposit account 54 and the RTN, the type of merchant, a merchant identifier, a location where the transaction was performed, a dollar amount of the transaction, a merchant category code, a date and time of the transaction, products purchased and related descriptions or identifiers, etc., in a transaction database 34. Alternatively, in one suitable embodiment, when the request for pre-authorization is accepted by the acquirer 14, the interchange network 16 (or an authorized representative) may immediately and directly transmit the information required to effect clearing/settlement via the ACH network 56 on-behalf of the merchant 12, thereby eliminating the need for the acquirer 14 to establish multiple processes.

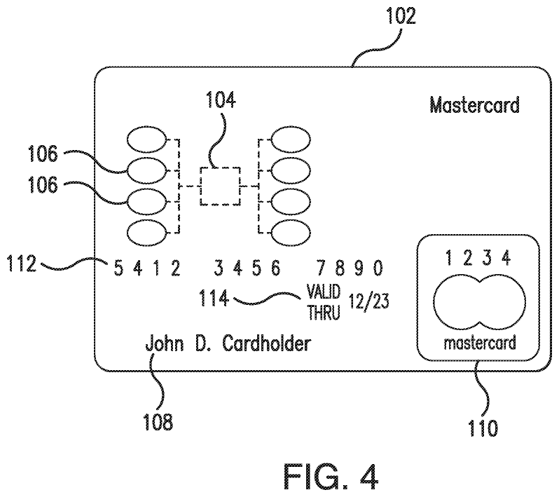

FIG. 4 is a schematic front view of the transaction card 102. In the exemplary embodiment, the transaction card 102 includes an embedded integrated circuit (IC) or micromodule 104 that stores and transmits transaction data between electronic devices. The micromodule 104 includes a single silicon integrated circuit chip with a memory device and a processor (not shown). Alternatively, in some embodiments, the micromodule 104 may only include memory with non-programmable logic. In the exemplary embodiment, the transaction data stored on the micromodule 104 is associated with one or more payment accounts linked to respective funding sources, such as the consumer deposit account 54 (shown in FIG. 2). As described herein, the transaction data includes the PAN, the account number of the consumer deposit account 54, and the RTN.

As shown in FIG. 4, the micromodule 104 includes a plurality of electrical contacts 106 for communication between the transaction card 102 and the POS terminal 32 (shown in FIG. 2). In addition, the transaction card 102 includes the consumer's name 108 and a logo 110 of a financial company whose services are used by the cardholder (e.g., Mastercard®). Moreover, the transaction card 102 includes the PAN 112 and an expiration date 114. The PAN 112 corresponds to the consumer deposit account 54, including the account number of the consumer deposit account 54, and the RTN included on the transaction card 102.

In an alternate embodiment, the transaction card 102 may be replaced by an integrated circuit device. The integrated circuit device may have a form factor different than that of the transaction card 102. For example, and without limitation, the integrated circuit device can be a mini-card, a key FOB, a contactless IC card, a computing device having a digital wallet, and the like. The integrated circuit device may include the micromodule 104, which may not be visible. Furthermore, the integrated circuit device may not include the other elements of the transaction card 102. The integrated circuit device may utilize the electrical contacts 106 for communications between the micromodule 104 and devices external to the integrated circuit device. Alternatively, the integrated circuit device may utilize different modes of communication with external devices including radio frequency communication and induction field (e.g., NFC) communication.

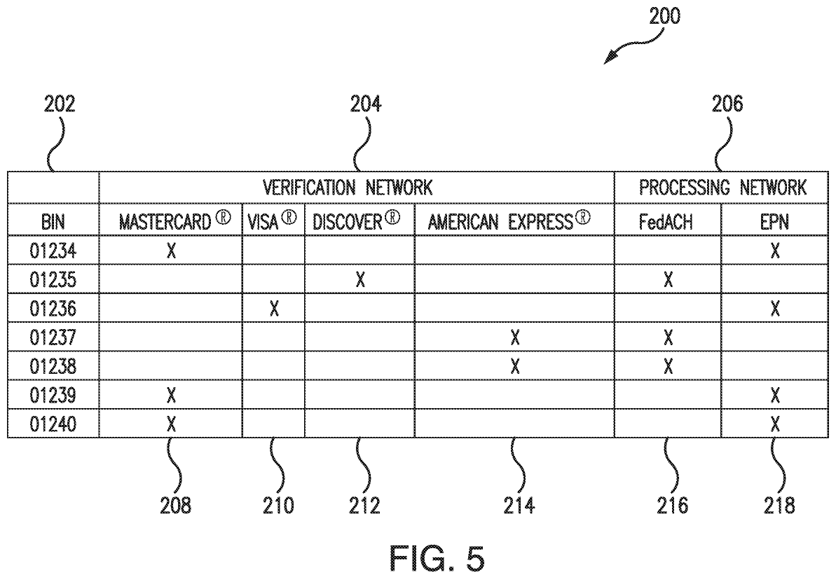

FIG. 5 is a schematic of a routing table 200 (or BIN routing table), in accordance with one embodiment of the present disclosure. The routing table 200 associates the Bank Identification Number (BIN), for example, of the transaction card 102 (shown in FIG. 4), with valid and eligible networks for verifying the availability of funds and processing transactions. A valid network is a debit/credit card network, such as the interchange network 16 (shown in FIG. 1) that may be used to verify funds availability and the ACH network 56 (shown in FIG. 2) that may be used to settle a transaction between a financial institution (e.g., the acquirer 14) or merchant 12 and the consumer 22 using a debit/credit card, such as the transaction card 102. It is noted that in some embodiments, an Issuer Identification Number (IIN) may be used instead of a BIN. An IIN is registered with the American Bankers Association and identifies the issuer of the transaction card 102.

The routing table 200 shown in FIG. 5 shows a BIN column 202, a verification network portion 204, and a processing network portion 206. The verification network portion 204 and the processing network portion 206 each include a number of network columns. For example, and without limitation, the verification network portion 204 includes network columns 208, 210, 212, and 214, whereas the processing network portion 206 includes network columns 216 and 218. The BIN column 202 includes a number of example BIN numbers. If a BIN is valid for routing with a verification network for verifying funds availability, the table location associated with the BIN and the eligible verification network is marked with an “X.” Likewise, if a BIN is valid for routing with a processing network for processing or settling a transaction, the table location associated with the BIN and the eligible processing network is marked with an “X.” It is noted that this is an example and that various ways of identifying verification and processing networks associated with a specific BIN may be used. Various other types of tables, files, and/or charts may be used to associate BINs with valid and eligible verification and processing networks. While the routing table 200 includes only four (4) verification network columns and two (2) processing network columns, any number of network columns may be included.

In the exemplary embodiment of FIG. 5, the first BIN “01234” of the routing table 200 has an “X” in the “MASTERCARD®” column 208 and the “EPN” (Electronic Payments Network) column 218. As such, the Mastercard network is designated as the eligible verification network for verifying that the account, such as the consumer deposit account 54 (shown in FIG. 2), associated with the transaction card has sufficient funds available to cover the transaction amount. In addition, the EPN network is the eligible processing network for processing (i.e., clearing and settling) the transaction. The second BIN “01235” has an “X” in the “DISCOVER®” column 212 and the “FedACH” column 216. As such, the Discover network is designated as the eligible verification network for verifying that the account, such as the consumer account 54, associated with the transaction card has sufficient funds available to cover the transaction amount. In addition, the FedACH network (i.e., the Federal Reserve Banks ACH Network) is the eligible processing network for processing the transaction. It is noted that similar information may be stored in a variety of ways. For example, and without limitation, the BIN routing information may be stored in a relational database and/or a linked list. The information need not be stored in a table format.

### Exemplary Computer Systems

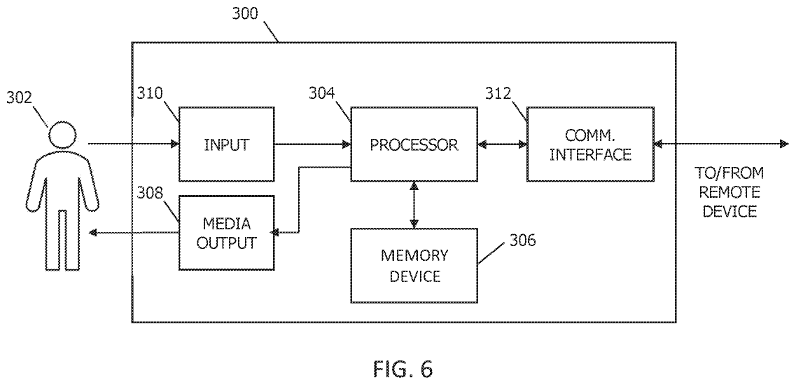

FIG. 6 is an example configuration of a computer system 300 operated by a user 302, such as the merchant 12 (shown in FIG. 3). In some embodiments, the computer system 300 is a merchant POS terminal 32 (shown in FIG. 1). In the example embodiment, the computer system 300 includes a processor 304 for executing instructions. In some embodiments, executable instructions are stored in a memory device 306. The processor 304 includes one or more processing units, for example, a multi-core configuration. The memory device 306 is any device allowing information such as transaction information, executable instructions, and/or written works to be stored and retrieved. The memory device 306 includes one or more computer readable media.

A location of the computer system 300 can be obtained through conventional methods, such as a location service (e.g., global positioning system (GPS) service) in the computer system 300, “ping” data that includes geotemporal data, from cell location register information held by a telecommunications provider to which the computer system 300 is connected, IP address register information, and the like. For example, in one suitable embodiment, a GPS chip can be part of or separate from the processor 304 to enable the location of the computer system 300 to be determined.

The computer system 300 also includes at least one media output component 308 for presenting information to the user 302. The media output component 308 is any component capable of conveying information to the user 302. In some embodiments, the media output component 308 includes an output adapter such as a video adapter and/or an audio adapter. An output adapter is operatively coupled to the processor 304 and operatively connectable to an output device such as a display device, a liquid crystal display (LCD), organic light emitting diode (OLED) display, or “electronic ink” display, or an audio output device, a speaker, or headphones.

In some embodiments, the computer system 300 includes an input device 310 for receiving input from the user 302. The input device 310 may include, for example, a touch sensitive panel, a transaction card scanner/reader, a touch pad, a touch screen, a stylus, a gyroscope, an accelerometer, a position detector, a keyboard, a pointing device, a mouse, or an audio input device. A single component such as a touch screen may function as both an output device of a media output component 308 and the input device 310. The computer system 300 may also include a communication interface 312 (e.g., a network interface), which is communicatively connectable to a remote device such as the interchange network 16 and the ACH network 56 (shown in FIG. 3). The communication interface 312 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax), and the like.

Stored in the memory device 306 are, for example, computer readable instructions for providing a user interface to the user 302 via the media output component 308 and, optionally, receiving and processing input from the input device 310. A user interface may include, among other possibilities, a web browser and/or a client application. Web browsers and/or the client application generally enable users, such as the user 302, to display and interact with media and other information typically embedded on a web page or a website available from the interchange network 16 and the ACH network 56.

In the example embodiment, the computing system 300 is a merchant computing device from which the merchant 12 engages with an acquirer (e.g., the acquirer 14 shown in FIG. 1), an interchange network (e.g., the interchange network 16 shown in FIG. 1), an ACH network (e.g., the ACH network 56 shown in FIG. 2), and an issuer of a transaction card (e.g., the issuer 18 shown in FIG. 1) to verify, in real-time, funds availability for a transaction that is processed via an ACH network.

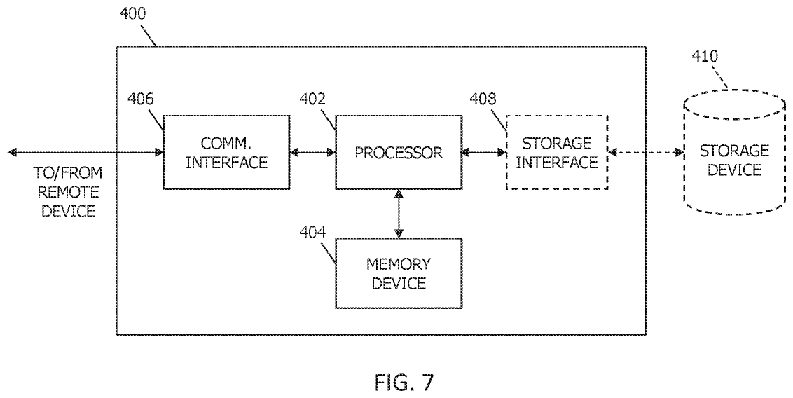

FIG. 7 is an example configuration of a server system 400, such as the server system 26 (shown in FIG. 1). The server system 400 includes, but is not limited to, the transaction database 24 (shown in FIG. 1), the database server 28 (shown in FIG. 1), and/or the transaction database 34 (shown in FIG. 3). In the example embodiment, the server system 400 includes a processor 402 for executing instructions. The instructions may be stored in a memory device 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 (e.g., a network interface) such that the server system 400 can communicate with a remote device such as a computer system 300 (shown in FIG. 6) or another server system 400. For example, the communication interface 406 may receive communications from the merchant POS terminal 32 via the Internet, as illustrated in FIGS. 1-3.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the storage devices of transaction databases 24 and 34. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory device 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In the example embodiment, server system 400 is a transaction verification and processing system in communication with one or more of the issuer 18 and the merchant 12 during a payment card transaction associated with a user, such as the consumer 22 (shown in FIGS. 1-3). The server system 400 performs checking for funds availability for consumer accounts (e.g., PANs) initiating a payment transaction and processes the payment transaction via an ACH network.

### Exemplary Computer-Implemented Methods

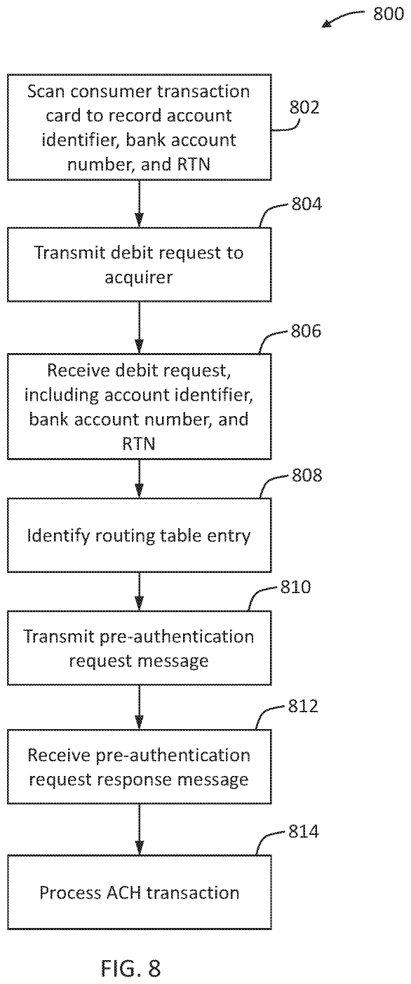

FIG. 8 is a flowchart illustrating an exemplary computer-implemented method 800 for real-time verification of funds availability for an ACH debit transaction where funds are transferred directly and electronically from a consumer deposit account, such as the consumer deposit account 54 (shown in FIG. 2), to a merchant account, such as the merchant account 52 (shown in FIG. 2), in accordance with one embodiment of the present disclosure. The operations described herein may be performed in the order shown in FIG. 8 or may be performed in a different order. Furthermore, some operations may be performed concurrently as opposed to sequentially. In addition, some operations may be optional.

The computer-implemented method 800 is described below, for ease of reference, as being executed by exemplary devices and components introduced with the embodiments illustrated in FIGS. 1-7. In one embodiment, the computer-implemented method 800 may be implemented by the acquirer 14 (shown in FIG. 3) using a computing device, such as the server system 400 (shown in FIG. 7). In the exemplary embodiment, the computer-implemented method 800 relates to pre-authorization of an ACH debit transaction using, for example, an interchange network to verify funds availability before performing the transaction on the ACH network. While operations within the computer-implemented method 800 are described below regarding the server system 400, the computer-implemented method 800 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, a consumer, such as the consumer 22 (shown in FIG. 3), performs a transaction at a merchant, such as the merchant 12 (shown in FIG. 3), using a transaction card, such as the transaction card 102 (shown in FIG. 3). Referring to operation 802, the transaction card 102 is scanned, or read, by the merchant, for example, using the POS terminal 32 (shown in FIG. 3). As described herein, the transaction card 102 includes an account identifier (e.g., a PAN) that is linked to the consumer's bank account, such as the consumer deposit account 54 (shown in FIG. 2), an account number of the consumer deposit account 54, and the associated routing transit number (RTN) of the issuer of the consumer deposit account 54, such as the issuer 18 (shown in FIG. 3). The POS terminal 32 reads and temporarily stores the PAN, the account number of the consumer deposit account 54, and the RTN as part of the transaction data. The transaction data may be stored for example, in the memory device 306 (shown in FIG. 6) of the POS terminal 32 (i.e., the computer system 300 (shown in FIG. 6)).

At operation 804, the merchant 12 transmits a debit request to an acquiring bank, such as the acquirer 14 (shown in FIG. 3). The debit request includes a copy of the stored transaction data and a transaction amount (i.e., an amount of funds requested to complete the transaction). At operation 806, the acquirer 14, via the server system 400 as described above, receives the debit request for the transaction. More specifically, the acquirer 14 receives a request to debit a first amount of funds from the consumer deposit account 54. Included in the debit request is the transaction data including the account identifier associated with the consumer deposit account (e.g., the PAN), the account number of the consumer deposit account 54, and the RTN of the issuer 18 of the consumer deposit account 54. As described herein, the PAN includes a Bank Identification Number (BIN) and/or an Issuer Identification Number (IIN).

At operation 808, the acquirer 14, via the server system 400, identifies an entry of a routing table, such as the routing table 200 (shown in FIG. 5), that matches the account identifier received with the debit request. In particular, the server system 400 extracts a BIN or IIN from the account identifier and compares it to the entries of the routing table 200. The system then determines a payment processing network that is eligible to process the transaction and a separate verification network that is eligible to verify the availability of a second amount of funds in the consumer deposit account from the entry corresponding to the BIN or IIN.

At operation 810, the system 400 transmits a pre-authorization request message to the identified verification network. More specifically, the system selects the verification network identified by the entry of the routing table, such as the interchange network 16, and transmits the pre-authorization request message on the selected network via a network interface, such as the communication interface 406 (shown in FIG. 7).

At operation 812, the system 400 receives, via the network interface, a pre-authorization response message from the verification network. The pre-authorization response message includes a second amount of funds available from the consumer deposit account 54. If the second amount of funds is greater than or equal to the requested first amount of funds in the debit request, the transaction is pre-authorized (accepted) for processing. If the second amount of funds is less than the requested first amount of funds in the debit request, the transaction is declined for insufficient funds.

At operation 814, if the transaction is pre-authorized, the system 400 processes the transaction using the identified payment processing network. More specifically, the system selects the payment processing network identified by the entry of the routing table, such as the ACH network 56, and transmits a transaction processing request to the issuer of the consumer deposit account, such as the issuer 18 via the selected network using, for example, the communication interface 406.

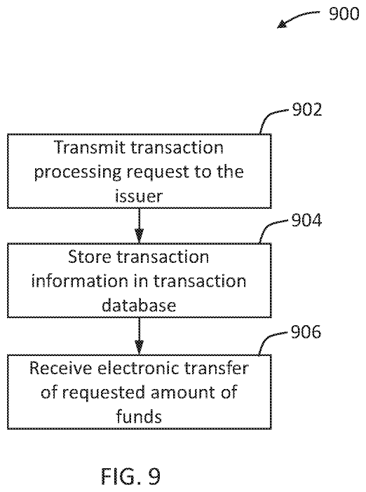

FIG. 9 is a flowchart illustrating the transaction processing details of operation 814 shown in FIG. 8. The operations described herein may be performed in the order shown in FIG. 9 or may be performed in a different order. Furthermore, some operations may be performed concurrently as opposed to sequentially. In addition, some operations may be optional.

The computer-implemented method 900 is described below, for ease of reference, as being executed by exemplary devices and components introduced with the embodiments illustrated in FIGS. 1-7. In one embodiment, the computer-implemented method 900 may be implemented by the acquirer 14 (shown in FIG. 3) using a computing device, such as the server system 400 (shown in FIG. 7). In the exemplary embodiment, the computer-implemented method 900 relates to processing a pre-authorized ACH transaction using an ACH network after receiving authorization for the transaction from an interchange network. While operations within the computer-implemented method 900 are described below regarding the server system 400, the computer-implemented method 900 may be implemented using any other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

Referring to operation 902, to process the transaction, the system 400 transmits a transaction processing request to the issuer of the consumer deposit account, such as the issuer 18, via the selected payment processing network using, for example, the communication interface 406 (shown in FIG. 7). As part of the initial debit request, the system 400 received an RTN for the issuer 18. The RTN received with the initial debit request identifies the issuer 18 for receipt of the transaction processing request. In the exemplary embodiment, the transaction processing request includes the first amount of funds to be transferred from the consumer deposit account 54 and the deposit account number of the consumer deposit account 54. At operation 904, the system 400 stores information regarding the transaction in a transaction database, such as the transaction database 34 (shown in FIG. 3). After transmission of the transaction processing request, at operation 906, the system 400 receives an electronic transfer of the first amount of funds from the consumer deposit account 54 for deposit in a merchant account, such as the merchant account 52 (shown in FIG. 2).

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as a field-programmable gate array (FPGA), to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as transceiver elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached drawing figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A method comprising:
receiving, for a transaction, a request to debit a first amount of funds from a consumer deposit account, the request including transaction data including an account identifier associated with the consumer deposit account;
identifying, using the account identifier, an entry of a routing table, wherein the entry identifies a payment processing network that is eligible to process the transaction, and a separate verification network that is eligible to verify a second amount of funds available from the consumer deposit account;
transmitting a pre-authorization request message to the verification network;
receiving a pre-authorization response message from the verification network verifying that the second amount of funds available from the consumer deposit account is greater than or equal to the first amount of funds; and
processing the transaction using the payment processing network.

2. The method in accordance with claim 1,
the transaction data comprising:
a primary account number (PAN) associated with the consumer deposit account, the PAN including a bank identification number (BIN);
a deposit account number of the consumer deposit account; and
a routing transit number (RTN) of an issuer of the consumer deposit account, wherein the account identifier comprises the BIN.

3. The method in accordance with claim 2,
the transmitting a pre-authorization request message operation comprising transmitting the pre-authorization request message including the PAN to identify the consumer deposit account.

4. The method in accordance with claim 2,
the processing the transaction operation comprising:
transmitting, via the payment processing network based on the RTN, a transaction processing request to the issuer of the consumer deposit account, the transaction processing request including the first amount of funds to be transferred from the consumer deposit account and the deposit account number of the consumer deposit account;
storing information regarding the transaction from the transaction request in a transaction database; and
receiving an electronic transfer of the first amount of funds from the consumer deposit account for deposit in a merchant account.

5. The method in accordance with claim 1,
the transmitting a pre-authorization request message operation comprising selecting the verification network identified by the entry of the routing table.

6. The method in accordance with claim 5,
the verification network comprising an interchange network.

7. The method in accordance with claim 1,
the processing the transaction operation comprising:
selecting the payment processing network identified by the entry of the routing table; and
transmitting a transaction processing request to an issuer of the consumer deposit account.

8. The method in accordance with claim 7,
the payment processing network comprising an automated clearing house (ACH) network.

9. A system comprising:
a network interface;
a memory device comprising a routing table; and
a processor communicatively coupled to the memory device, the processor programmed to:
receive a transaction from a merchant via the network interface, the transaction comprising a request to debit a first amount of funds from a consumer deposit account, the request including transaction data including an account identifier associated with the consumer deposit account;
identify, using the account identifier, an entry of the routing table, wherein the entry identifies a payment processing network that is eligible to process the transaction, and the entry identifies a separate verification network that is eligible to verify a second amount of funds available from the consumer deposit account;
transmit a pre-authorization request message to the verification network via the network interface;
receive, via the network interface, a pre-authorization response message from the verification network verifying that the second amount of funds available from the consumer deposit account is greater than or equal to the first amount of funds; and
process the transaction using the payment processing network.

10. The system in accordance with claim 9, wherein the transaction data comprises:
a primary account number (PAN) associated with the consumer deposit account, the PAN including a bank identification number (BIN);
a deposit account number of the consumer deposit account; and
a routing transit number (RTN) of an issuer of the consumer deposit account, wherein the account identifier comprises the BIN.

11. The system in accordance with claim 10, wherein the processor is programmed to transmit the PAN to identify the consumer deposit account as part of the pre-authorization request message.

12. The system in accordance with claim 10, wherein the processor is further programmed, as part of the operation of processing the transaction, to:
transmit, via the payment processing network based on the RTN, a transaction processing request to the issuer of the consumer deposit account, the transaction processing request including the first amount of funds to be transferred from the consumer deposit account and the deposit account number of the consumer deposit account;
store information regarding the transaction from the transaction request in a transaction database; and
receive an electronic transfer of the first amount of funds from the consumer deposit account for deposit in a merchant account.

13. The system in accordance with claim 9, wherein the processor is programmed to select the verification network identified by the entry of the routing table, as part of the operation of transmitting the pre-authorization request message.

14. The system in accordance with claim 13, wherein the verification network comprises an interchange network.

15. The system in accordance with claim 9, wherein the processor is further programmed, as part of the operation of processing the transaction, to:
select the payment processing network identified by the entry of the routing table; and
transmit a transaction processing request to an issuer of the consumer deposit account.

16. The system in accordance with claim 15, wherein the payment processing network comprising an automated clearing house (ACH) network.

17. One or more non-transitory computer-readable storage media having computer-executable instructions embodied thereon, wherein when executed by at least one processor, the computer-executable instructions cause the processor to:
receive, for a transaction, a request to debit a first amount of funds from a consumer deposit account, the request including transaction data including an account identifier associated with the consumer deposit account;
identify, using the account identifier, an entry of a routing table, wherein the entry identifies a payment processing network that is eligible to process the transaction, and the entry identifies a separate verification network that is eligible to verify a second amount of funds available from the consumer deposit account;
transmit a pre-authorization request message to the verification network;
receive a pre-authorization response message from the verification network verifying that the second amount of funds available from the consumer deposit account is greater than or equal to the first amount of funds; and
process the transaction using the payment processing network.

18. The non-transitory computer-readable storage media in accordance with claim 17, wherein the transaction data comprises:
a primary account number (PAN) associated with the consumer deposit account, the PAN including a bank identification number (BIN);
a deposit account number of the consumer deposit account; and
a routing transit number (RTN) of an issuer of the consumer deposit account, wherein the account identifier comprises the BIN.

19. The non-transitory computer-readable storage media in accordance with claim 18, wherein the computer-executable instructions further cause the processor to transmit the PAN to identify the consumer deposit account as part of the pre-authorization request message.

20. The non-transitory computer-readable storage media in accordance with claim 18, wherein the computer-executable instructions for processing the transaction further cause the processor to:
transmit, via the payment processing network based on the RTN, a transaction processing request to the issuer of the consumer deposit account, the transaction processing request including the first amount of funds to be transferred from the consumer deposit account and the deposit account number of the consumer deposit account;
store information regarding the transaction from the transaction request in a transaction database; and
receive an electronic transfer of the first amount of funds from the consumer deposit account for deposit in a merchant account.
